(19) United States
(12) Patent Application Publication
(10) Pub. No.: US 2006/0159440 A1
(43) Pub. Date: Jul. 20, 2006

(54) Method and apparatus for disrupting an autofocusing mechanism

(75) Inventors: Debashish Purkayastha, Pottstown, PA (US); Alain Charles Louis Briancon, Poolesville, MD (US); John Thommana, Cedar Rapids, IA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/285,892

(22) Filed: Nov. 23, 2005

Related U.S. Application Data
(60) Provisional application No. 60/631,328, filed on Nov. 29, 2004.

(51) Int. Cl. G03B 13/32

(52) U.S. Cl. 396/89

(57) ABSTRACT

An automatic anti-focusing mechanism which generates and emits one or more distortion signals includes one or more sound or light generators which generate the distortion signals in various portions of their respective spectrums. The emitted distortion signals are received by an active automatic focusing camera and inhibit the ability of the active automatic focusing camera to properly detect a signal reflected off of a subject. Accordingly, the ability of the active automatic focusing camera to properly focus upon a subject is severely limited or disabled.

### CROSS REFERENCE TO RELATED APPLICATION

This application claims the benefit of U.S. Provisional Application No. 60/631,328, filed on Nov. 29, 2004 which is incorporated by reference as if fully set forth.

### FIELD OF INVENTION

The present invention is related to automatic focusing cameras. More particularly, the present invention is a method and apparatus for preventing unwanted picture taking by interfering with the focusing mechanism of an automatic camera.

### BACKGROUND

As the state of technology in both digital and analog cameras has advanced, cameras have become much easier for ordinary individuals to use. High quality picture taking, once largely reserved for professionals, is now available to individuals with little or no photography experience. This is primarily the result of automatic focusing mechanisms which allow unskilled photographers to “point and shoot” in order to take a picture. Using a typical automatic focusing mechanism, an unskilled user with little forethought, can point the camera at a desired subject, depress an actuator and rely upon the camera to make the necessary adjustments to bring the desired subject into focus. Similarly, cameras are also capable of calculating the desired exposure based upon ambient light conditions. This has resulted in a tremendous infusion of the technology into existing cameras and, as a result, such cameras are ubiquitous.

The technology has spread to everyday consumer items such as camera phones and other consumer electronics. For example, sales of cell phones with embedded cameras now number in the hundreds of millions. Proliferation of this technology, however, has serious negative social consequences in that the privacy of individuals and businesses is often easily violated. For example, situations which would have been fleeting are now captured via pictures or videos and posted on the internet within hours. Certain individuals, such as celebrities or public officials are inundated with the paparazzi and other individuals incessantly taking videos and/or pictures.

Likewise, businesses are subjected to theft and piracy via individuals who gain access to the business establishments under what appear to be legitimate reasons. However, using miniature cameras and/or video recorders, these individuals obtain information in an unauthorized manner. With current technology, the unauthorized capture and recording of information has been made very easy.

Referring to FIG. 1, a diagram for graphically illustrating different types of cameras 10 is shown. Although FIG. 1 is directed to still-picture cameras 10, this is only an example. The present invention is related to any type of video or picture taking devices which utilize an automatic focusing mechanism.

Cameras 10 can generally be separated into two types; manual focusing cameras 20 and automatic focusing cameras 30. The present invention is related to automatic focusing cameras 30. Further, automatic focusing cameras 30 can be generally separated into two subtypes: active automatic focusing cameras 40 and passive automatic focusing cameras 50. With a passive automatic focusing camera 50, the camera emits neither sound nor light when it performs a focusing adjustment. These passive automatic focusing cameras 50 typically include a charged coupled device (CCD) which contains a plurality of pixel elements that absorb incident light. Operating on the amount of light incident on each pixel, various kinds of prior art algorithms are used to bring subject S into focus. These algorithms work on the premise that there are contrasting portions of the projection of the subject S on the CCD. The algorithms measure the amount of reflected light on the pixels to establish whether or not there is significant contrast between adjacent pixels. When juxtaposed pixels have similar intensity, it implies that the subject S is out of focus and the lens is adjusted until there is a marked difference between the intensity of adjacent pixels.

The present invention is related to active automatic focusing cameras 40. Active automatic focusing cameras 40 generally employ two methods for focusing a camera; namely sound navigation and ranging (SONAR) and infrared (IR) emissions. Referring to FIG. 2, active automatic focusing cameras 40 using SONAR emit ultra-high frequency (UHF) sound pulses 42 at a subject S and detect a reflected signal 44. The difference between the time of sending the emitted signal 42 and the time of arrival of the reflected signal 44 is calculated in order to gauge a distance (or range) to the subject S. This is ultimately gets translated into motor movement to advance or retract a lens to properly focus the camera 40. An active automatic focusing camera 40 utilizing infrared emissions operates in a similar manner except that infrared light pulses are emitted, instead of SONAR pulses.

What is needed is a system and method to disable the ability of an active automatic focusing camera 40 to properly focus on a subject S. This will provide at least some measure of privacy.

### SUMMARY

The present invention is an automatic anti-focusing mechanism which generates and emits one or more distortion signals. The automatic anti-focusing mechanism includes one or more sound or light generators which generate the distortion signals in various portions of their respective spectrums. The emitted distortion signals are received by an active automatic focusing camera and inhibit the ability of the active automatic focusing camera to properly detect a signal reflected off of a subject. Accordingly, the ability of the active automatic focusing camera to properly focus upon a subject is severely limited or disabled.

### BRIEF DESCRIPTION OF THE DRAWINGS

FIG. 1 is a diagram illustrating different types of cameras.

FIG. 2 is a perspective view of a prior art active automatic focusing camera.

FIG. 3 is an automatic anti-focusing mechanism in accordance with the present invention.

FIG. 4 is a perspective view of the operation of the automatic anti-focusing mechanism of FIG. 3 in accordance with the present invention.

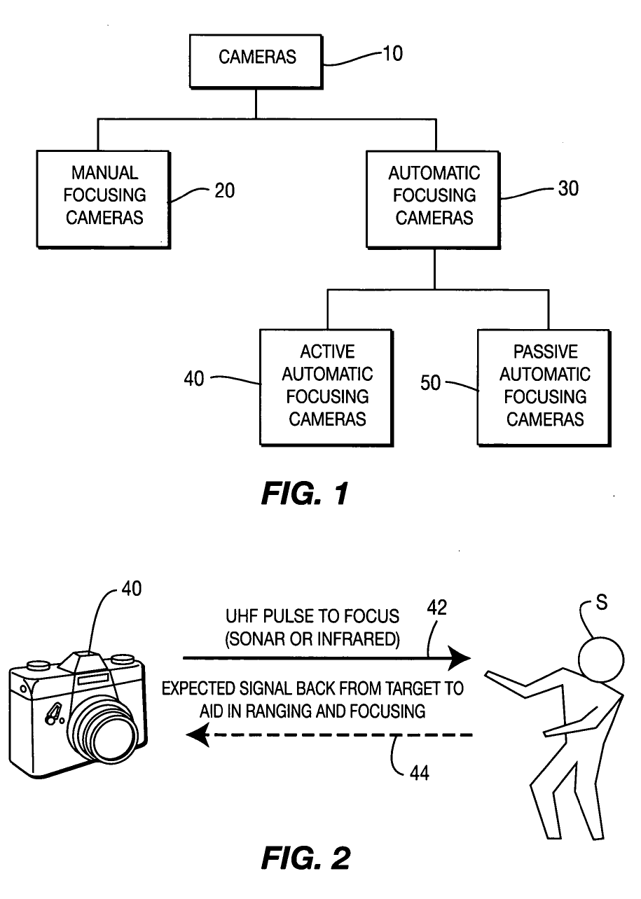

### DETAILED DESCRIPTION OF THE PREFERRED EMBODIMENTS

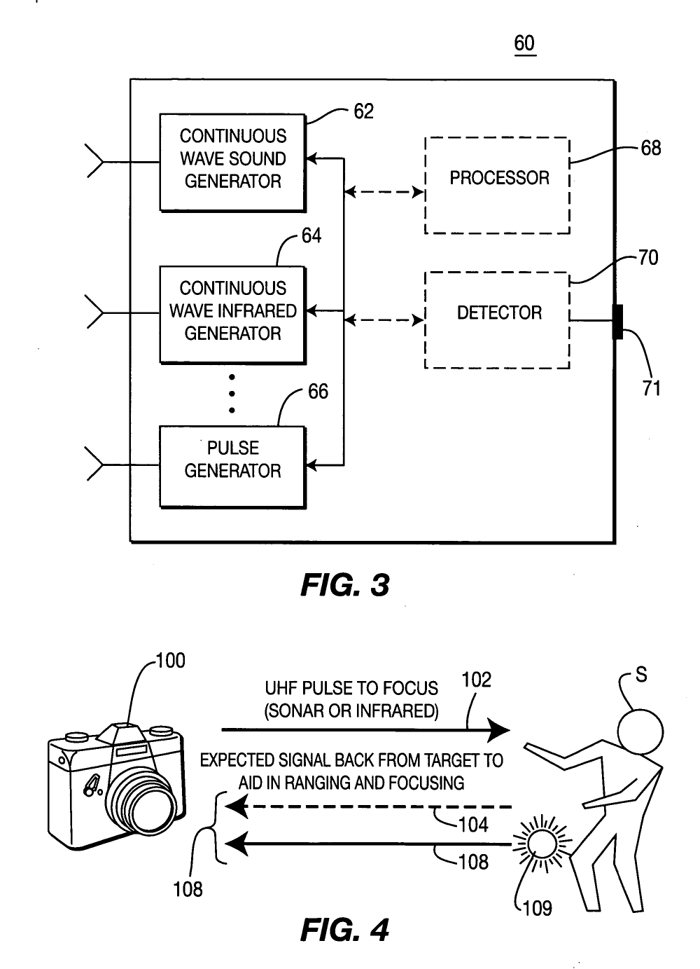

The present invention will be described with reference to the drawing figures wherein like numerals represent like elements throughout. Referring to FIG. 3, an automatic anti-focusing mechanism 60 is shown. The anti-focusing mechanism 60 includes one or more of a continuous wave sound generator 62, a continuous wave infrared generator 64 and/or pulse generator 66.

The features of the present invention may be incorporated into an integrated circuit (IC) or be configured in a circuit comprising a multitude of interconnecting components.

The continuous wave sound generator 62 presents a continuous source of sound in the typical SONAR ranges such that it interferes or overwhelms a SONAR-based active automatic focusing camera.

The continuous wave infrared generator 64 presents a continuous source of infrared light such that an infrared-based active automatic focusing camera.

In many applications other then cameras, pulses are used to find the distance to a subject S. The pulse generator 66 presents a continuous background of pulses such that, for example, a pulse laser distance finder will be confused by the emissions. The pulse generator 66 can generate pulsed signals of any kind. For example, it may generate one, or a combination of, sound (SONAR), visible or infrared pulses. This is another mechanism to confuse an active automatic focusing mechanism. Although the continuous wave sound generator 62, the continuous infrared generator 64 and the pulse generator 66 have been shown as individual components, those of skill in the art would recognize that combinations of components may be utilized to achieve the same results. For example, a sound generator may emit both continuous sound and sound pulses. Likewise, a light generator might emit both intermittent pulses and/or continuous light emissions. In the case that range detection may be ultra wideband, a continuous background of pulses are generated by a beacon encoded by a known whatever bit sequence that is used.

Whether the emission comes from the continuous wave sound generator 62, the continuous wave infrared generator 64 or the pulse generator 66, or from several of those sources, the emission forms a distortion signal. The distortion signal is sent toward an active automatic focusing camera. This distortion signal will be received by the active automatic focusing camera along with the signal reflected from the subject S. The distortion signal is designed to overwhelm the ability of the active automatic focusing camera to accurately detect the reflected signal and impair the ability of the active automatic focusing camera to properly focus upon the subject S.

Since knowledge of the particular pulse sequence, SONAR pulse, infrared or visible light emission for every camera that is produced is not feasible, it is preferable that various emission generators are used to produce emissions in every applicable frequency range. For example, although ranging operations generally include SONAR or infrared emissions, it is possible to generate signals in all frequency ranges such as low frequency (LF), medium frequency (MF), high frequency (HF), very high frequency (VHF), ultra high frequency (UHF), etc. Any of these frequency ranges may confuse present or future automatic focusing mechanisms. Such confused automatic focusing mechanisms will create blurred and unusable images. Multiple infrared emissions of varying intensities will also cause under-exposure or over-exposure lighting conditions.

In an alternative embodiment, as shown by the dashed-outlined boxes of FIG. 3, a processor 68 and a detector 70 (including a sensor 71) may be included. For this alternative, a detector 70 detects, via the sensor 71, the emission coming from an active automatic focusing camera and the processor 68 determines which type of emission is present. The processor 68 then controls one or more of the generators 62, 64, 66 to generate the proper distortion signal. With this embodiment, it is not necessary to continuously generate sound and/or light emissions, rather, they are only generated.

Referring to FIG. 4, the operation of the present invention will be explained. An active automatic focusing camera 100, whether SONAR, infrared or any other type of ranging source, emits one or more pulses streams or continuous waves 102 toward a subject S. In accordance with the present invention, a distortion generator 109 emits one or more different types of distortion signals 108 toward the active automatic focusing camera 100. A reflected signal 104, which is a result of the signal 102 being reflected off the subject S, is also sent toward the active automatic focusing camera 100. A composite signal 110 comprising the reflected signal 104 and the one or more distortion signals 108 is received at the active automatic focusing camera 100. This composite signal 110 makes it difficult for the active automatic focusing camera 100 to accurately detect the reflective signal 104. As a result, it is difficult or impossible for the active automatic focusing camera 100 to gain an accurate reading the range of the subject S and, therefore, the active automatic focusing camera 100 is unable to properly focus upon the subject.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. Apparatus for disabling an automatic focusing mechanism which emits a signal toward a subject and receives a signal reflected from the subject in order to calculate a distance to the subject, the device comprising:
a distortion generator which generates a distortion signal in the same frequency range as the emitted signal, such that the automatic focusing mechanism receives both the reflected signal and the distortion signal.

2. The apparatus of claim 1 wherein the distortion generator further includes a sound generator and the distortion signal includes a sound wave.

3. The apparatus of claim 2 wherein the sound wave is continuous.

4. The apparatus of claim 2 wherein the sound wave is intermittent.

5. The apparatus of claim 1 wherein the distortion generator further includes an infrared generator for generating an infrared emission.

6. The apparatus of claim 5 wherein the infrared emission is continuous.

7. The apparatus of claim 5 wherein the infrared emission is intermittent.

8. The apparatus of claim 1 wherein the distortion generator comprises:
a detector for detecting the emitted signal; and
a processor for determining the type of detected signal and for controlling the type of distortion signal to generate.

9. An integrated circuit (IC) for disabling an automatic focusing mechanism which emits a signal toward a subject and receives a signal reflected from the subject in order to calculate a distance to the subject, the IC comprising:
a distortion generator which generates a distortion signal in the same frequency range as the emitted signal, such that the automatic focusing mechanism receives both the reflected signal and the distortion signal.

10. The IC of claim 9 wherein the distortion generator further includes a sound generator and the distortion signal includes a sound wave.

11. The IC of claim 10 wherein the sound wave is continuous.

12. The IC of claim 10 wherein the sound wave is intermittent.

13. The IC of claim 9 wherein the distortion generator further includes an infrared generator for generating an infrared emission.

14. The IC of claim 13 wherein the infrared emission is continuous.

15. The IC of claim 13 wherein the infrared emission is intermittent.

16. The IC of claim 9 wherein the distortion generator comprises:
a detector for detecting the emitted signal; and
a processor for determining the type of detected signal and for controlling the type of distortion signal to generate.

17. A method of disabling an automatic focusing mechanism comprising:
(a) the automatic focusing mechanism emitting a first signal toward a subject;
(b) the automatic focusing mechanism receiving a second signal reflected from the subject;
(c) the automatic focusing mechanism using the second signal to calculate a distance to the subject; and
(d) the automatic focusing mechanism generating a distortion signal in the same frequency range as the first signal, such that the automatic focusing mechanism receives both the second signal and the distortion signal.

18. The method of claim 17 wherein the distortion generator further includes a sound generator and the distortion signal includes a sound wave.

19. The method of claim 18 wherein the sound wave is continuous.

20. The method of claim 18 wherein the sound wave is intermittent.

21. The method of claim 17 further comprising:
(e) the automatic focusing mechanism generating an infrared emission.

22. The method of claim 21 wherein the infrared emission is continuous.

23. The method of claim 21 wherein the infrared emission is intermittent.

24. The IC of claim 9 wherein step (d) further comprises:
(d1) detecting the first signal; and
(d2) determining the type of the first signal; and
(d3) controlling the type of distortion signal to generate.
